(19) United States
(12) Patent Application Publication
(10) Pub. No.: US 2012/0124370 A1
(43) Pub. Date: May 17, 2012

(54) PORTABLE INTEGRATED SECURITY STORAGE DEVICE AND SERVICE PROCESSING APPARATUS, AND SERVICE PROCESSING METHOD USING THE SAME

(75) Inventors: Byeong Cheol CHOI, Daejeon (KR); Jae Deok LIM, Daejeon (KR); Seung Wan HAN, Daejeon (KR)

(73) Assignee: Electronics and Telecommunications Research Institute, Daejon (KR)

(21) Appl. No.: 13/294,326

(22) Filed: Nov. 11, 2011

(30) Foreign Application Priority Data
Nov. 12, 2010 (KR) 10-2010-0112731

(51) Int. Cl. H04L 29/06

(52) U.S. Cl. 713/159

(57) ABSTRACT

A portable integrated security storage device includes: a password generation module for generating a password; a universal authentication module for storing universal authentication information; a communication interface connected to an external system for transmitting and receiving data with the external system; and a memory for storing the received data received through communication with the external system. The password and universal authentication information are transmitted to the external system for user authentication and device authentication, and encrypted data and a service secret key are received from the external system and stored in the memory.

### CROSS-REFERENCE(S) TO RELATED APPLICATION(S)

The present invention claims priority of Korean Patent Application No. 10-2010-0112731, filed on Nov. 12, 2010, which is incorporated herein by reference.

### FIELD OF THE INVENTION

The present invention relates to a security storage device, and more particularly, to a portable integrated security storage device into which a universal authentication module, a password generation module and a large capacity memory are combined and a service processing apparatus, and service processing method using the same.

### BACKGROUND OF THE INVENTION

The use of electronic commerce and charged contents in a mobile device has recently increased due to an increase in the use of a smart phone. In order to use such electronic commerce and charged contents, a security authentication device is required.

Examples of a security authentication method being currently used for a mobile service may include a one time password (OTP), a universal subscriber identity module (USIM), public certificate, and the like used for general electronic commerce and charged contents, each of which is used separately for user authentication and electronic commerce.

However, since OTP and USIM are currently managed as a separate device and a memory capacity thereof is small, a large amount of information and data cannot be stored and a duplication prevention function cannot also be supported. Thus, a service provider only has a solution in order to strength duplication prevention for charged information and data which is setting the charged information or data to be used only in a device which has requested and paid for the information or data.

That is, in case of an existing security storage device, since there are difficulties in interworking between authentication devices due to separate management and duplication prevention of data cannot be supported, mobility of security is not satisfied.

### SUMMARY OF THE INVENTION

In view of the above, the present invention provides a portable integrated security storage device capable of generating universal authentication information and a password, supporting a large capacity memory and being connected to various systems through a communication interface.

Further, the present invention provides a service processing apparatus and method using a portable integrated security storage device, the service processing apparatus being able to receive a service from a service providing server through its connection to the portable integrated security storage device which manages universal authentication information and a password.

The present invention is not limited thereto, and all other objects that are not described above will be apparently understood by those skilled in the art from the following description.

In accordance with an aspect of the present invention, there is provided a portable integrated security storage device including: a password generation module for generating a password; a universal authentication module for storing universal authentication information; a communication interface connected to an external system for transmitting and receiving data with the external system; and a memory for storing the received data received through communication with the external system.

The password and universal authentication information are transmitted to the external system for user authentication and device authentication, and encrypted data and a service secret key are received from the external system and stored in the memory.

In accordance with another aspect of the present invention, there is provided with a service processing apparatus using a portable integrated security storage device including: a service request unit for receiving a password and universal authentication information from the portable integrated security storage device which manages the password and the universal authentication information, and then providing the password, the universal authentication information and user encryption information for generation of a service secret key to a service providing server connected through a wired/wireless communications network to request a service; and a secret key processing unit for receiving the encryption information used for the generation of the service secret key from the service providing server, and then generating the service secret key by using the encryption information, and storing the generated service secret key in the portable integrated security storage device.

The apparatus further includes a data processing unit for receiving encrypted data from the service providing server in response to a service request from the service request unit, decoding the encrypted data by using the service secret key stored in the portable integrated security storage device or storing the encrypted data in the portable integrated security storage device.

In accordance with still another aspect of the present invention, there is provided a service processing method using a portable integrated security storage device including: receiving a password and universal authentication information when the portable integrated security storage device which manages the password and the universal authentication information is connected; providing the password, the universal authentication information and user encryption information for generation of a service secret key to a service providing server connected through a wired/wireless communications network to request a service; receiving encryption information used for the generation of the service secret key from the service providing server; generating the service secret key by using the received encryption information, and storing the generated service secret key in the portable integrated security storage device; receiving data encrypted by using the service secret key from the service providing server; and decoding the encrypted data by using the service secret key stored in the portable integrated security storage device or storing the encrypted data in the portable integrated security storage device.

### BRIEF DESCRIPTION OF THE DRAWINGS

The objects and features of the present invention will become apparent from the following description of embodiments, given in conjunction with the accompanying drawings, in which:

FIG. 1 is a block diagram showing a configuration of a portable integrated security storage device in accordance with an embodiment of the present invention;

FIG. 2 is shows a system performing a process of authentication for a user or device and a process of exchanging a service secret key using the portable integrated security storage device in accordance with the embodiment of the present invention;

FIG. 3 is a diagram showing an example of apparatuses connected to the portable integrated security storage device in accordance with the embodiment of the present invention; and

FIG. 4 is a flowchart showing a process in which data is provided at a service request using the portable integrated security storage device in accordance with the embodiment of the present invention.

### DETAILED DESCRIPTION OF THE EMBODIMENTS

Hereinafter, an embodiment of the present invention will be described in detail with reference to the accompanying drawings which form a part hereof.

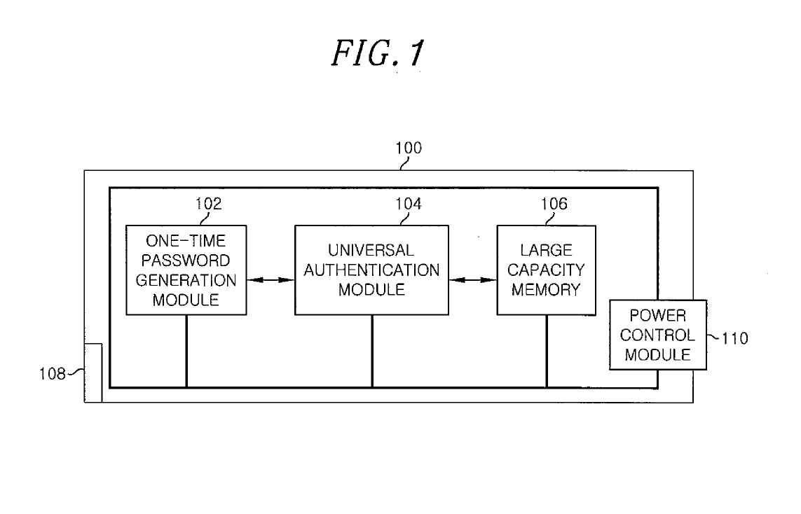

FIG. 1 is a block diagram showing a configuration of a portable integrated security storage device in accordance with the embodiment of the present invention. The integrated security storage device includes a one-time password generation module 102, a universal authentication module 104, a large capacity memory 106, a communication interface 108, a power control module 110 and the like.

The one-time password generation module 102 generates one-time password in order to strengthen security for a system using the portable integrated security storage device, and an example thereof may be one time password (OTP).

The universal authentication module 104 generates universal authentication information for user authentication, and an example thereof may be a universal subscriber identity module (USIM) chip.

The large capacity memory 106 stores a service secret key K and encoded data received by the system connected to the portable integrated security storage device. Such large capacity memory 106 supports a universal serial bus (USB) interface or a secure digital (SD) card interface.

The communication interface 108 is an interface for making a connection with the system using the portable integrated security storage device, and an example thereof may be a USB port, an SD card port or the like.

The power control module 110 is provided to supply power to the portable integrated security storage device. As an example thereof, there may be a chargeable battery, a disposable battery, a mercury cell or the like.

The portable integrated security storage device having the configuration described above is connected to a system, e.g., a mobile communication terminal such as a smart phone, through the communication interface 108. One-time password generated by the one-time password generation module 102 and the universal authentication information generated by the universal authentication module 104 are provided to the mobile communication terminal, when a service request is transmitted to a service providing system connected through a wireless communication network.

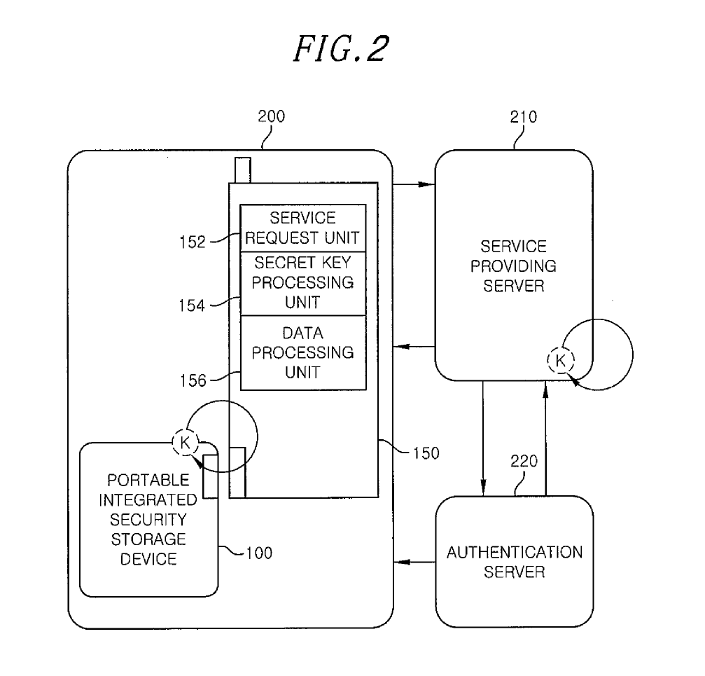

An example to which the portable integrated security storage device as mentioned above is applied will be described with reference to FIG. 2.

FIG. 2 shows a system performing a process of authentication for a user or device and a process of exchanging a service secret key by using the portable integrated security storage device in accordance with the embodiment of the present invention. The system in FIG. 2 includes a user party 200 having a mobile device 150 connected to the portable integrated security storage device 100, a service providing server 210, an authentication server 220 and the like. Here, the mobile device 150 is a wireless terminal that is connected to the service providing server 210 through the wireless communications network to receive a service. The mobile device 150 may be, e.g., a smart phone, a mobile phone, a personal digital assistant (PDA), or the like.

In an embodiment of the present invention, a Diffie-Hellman key exchange method may be used for a key exchange between the portable integrated security storage device 100 and the mobile device 150.

The portable integrated security storage device 100 provides one-time password generated by the one-time password generation module 102 and universal authentication information generated by the universal authentication module 104 to the mobile device 150 by using the Diffie-Hellman key exchange method.

When a user accesses the service providing server 210 to request a service, the mobile device 150 transmits encryption information for generation of a service secret key, the one-time password received from the portable integrated security storage device 100 and the universal authentication information to the service providing server 210 to request authentication therefor.

In addition, the mobile device 150 receives the encryption information of the service providing server 210 as a response of the service providing server 210 upon the request of authentication and generates the service secret key by using the encryption information received from the service providing server 210.

Also, the mobile device 150 receives the encrypted information or data from the service providing server 210 in response to a user's service request and temporarily stores the encrypted information or data in the large capacity memory 106 of the portable integrated security storage device 100.

The mobile device 150 decodes the encrypted information or data in the large capacity memory 106 to then display the decoded information or data. That is, the mobile device 150 generates the service secret key by using the encryption information provided by the service providing server 210 and then decodes the encrypted information or data by using the generated service secret key.

The mobile device 150 includes a service request unit 152 for receiving the one-time password and the universal authentication information from the portable integrated security storage device 100 and then providing the one-time password, the universal authentication information and user encryption information for generation of a service secret key to the service providing server 210 connected through the wireless communications network therewith; and a secret key processing unit 154 for receiving the encryption information used for the generation of the service secret key from the service providing server 210 and then generating the service secret key by using the user encryption information, and storing the generated service secret key in the large capacity memory 106 of the portable integrated security storage device 100. The mobile device 150 further includes a data processing unit 156 for receiving encrypted data from the service providing server 210 in response to a service request from the service request unit 152, decoding the encrypted data by using the service secret key stored in the large capacity memory 106 of the portable integrated security storage device 100 or storing the encrypted data in the portable integrated security storage device 100.

The service providing server 210 transmits the one-time password and the universal authentication information to the authentication server 220 to perform authentication for the user of the mobile device 150 and the portable integrated security storage device 100. In other words, the service providing server 210 transmits the one-time password and the universal authentication information to the authentication server 220 and then receives a response thereto, whereby authentication for the user of the mobile device 150 and the portable integrated security storage device 100 can be performed.

Also, the service providing server 210 generates a service secret key K based on encryption information in order to securely use user information as wall as various information and data by using the encryption information, and transmits the encryption information of the service providing server 210 used for the generation of the service secret key K to the mobile device 150 of the user party 200.

The authentication server 220 receives the universal authentication information and the one-time password from the service providing server 210 to perform authentication for the portable integrated security storage device 100 and the user by using them. Subsequently, the authentication server 220 provides authentication results to the service providing server 210.

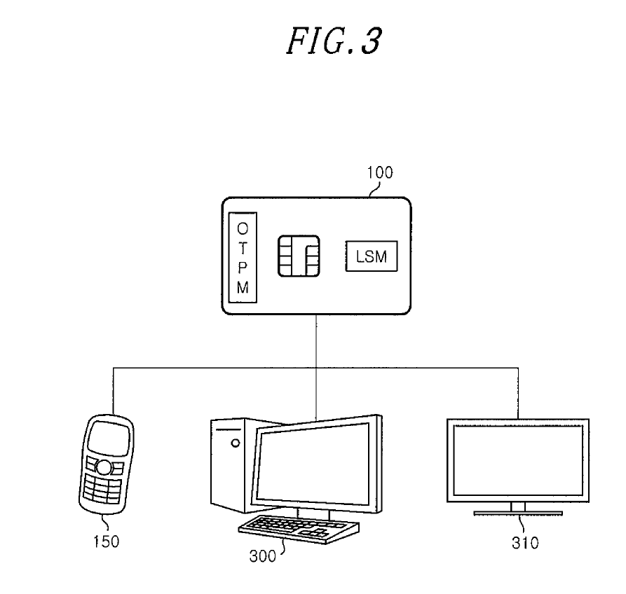

Although the embodiment of the present invention describes a case in which the portable integrated security storage device 100 is connected to the mobile device 150 by way of example, the portable integrated security storage device 100 may be connected to a personal computer 300 such as a laptop computer or the like, a television (TV), an internet protocol television (IPTV), or the like, as shown in FIG. 3. In other words, encrypted data within the large capacity memory 106 of the portable integrated security storage device 100 may be decoded by the personal computer 300, TV, IPTV 310 or the like and then provided to a user.

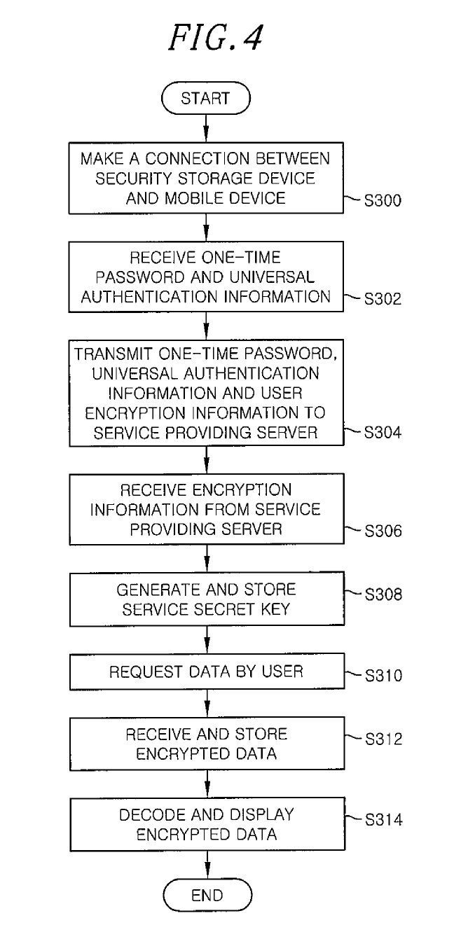

Now, a process in which the mobile device 150 having the above-described configuration requests a service providing server to provide a service and receives the requested service will be described with reference to FIG. 4.

FIG. 4 is a flowchart showing a process in which data is provided at a service request using the portable integrated security storage device in accordance with the embodiment of the present invention.

As shown in FIG. 4, as the portable integrated security storage device is connected to the mobile device 150 through the communication interface 108 of the portable integrated security storage device 100 in step S300, the service request unit 152 in the mobile device 150 receives one-time password generated by the one-time password generation module 102 in the portable integrated security storage device 100 and the universal authentication information stored in the universal authentication module 104 in step S302, and then provide the received one-time password and universal authentication information, and user encryption information for generation of a service secret key to the service providing server 210 in step S304 (i.e., g^{α} mod p∥USIM Info.∥#(OTP), where g^{α} mod p is user encryption information, the USIM Info. is universal authentication information, and the #(OTP) is one-time password).

Accordingly, the service providing server 210 transmits the universal authentication information and the one-time password to the authentication server 220 to request authentication (USIM Info.∥#(OTP)) and receives a response thereto (ACK (acknowledgement) message transmission) as authentication result. In other words, the service providing server 210 performs authentication for the user of the mobile device 150 and the portable integrated security storage device 100 through the authentication server 220 that is an issue and authentication unit for the portable integrated security storage device 100.

When a response to the authentication result is received, the service providing server 210 generates the service secret key K (where K=(g^{α})^{β} mod p, with p being encryption information of the service providing server) for safe use of the user and data and may provide the encryption information of the service providing server 210 used for generating the service secret key K to the mobile device 150 (g^{α} mod p∥#(OTP)). That is, the secret key processing unit 154 in the mobile device 150 receives the encryption information from the service providing server 210 in step S306, and then generates the service secret key K (where K=(g^{β})^{α} mod p) by using the received encryption information and stores the generated service secret key K in the large capacity memory 106 in the portable integrated security storage device 100 in step S308.

Thereafter, when there is a user's data request in step S310, the data processing unit 156 of the mobile device 150 receives data encrypted by using the service secret key K from the service providing server 210 and then stores the encrypted data in the large capacity memory 106 in the portable integrated security storage device 100 in step S312.

Next, the data processing unit 156 in the mobile device 150 decodes the encrypted data stored in the large capacity memory 106 by using the service secret key K to display the decoded data.

In accordance with the embodiment of the present invention, the portable integrated security storage device 100 including the modules for generating the universal authentication information and the one-time password is provided to substitute for the existing OTP, USIM or public certificate scheme as well as supporting a wired terminal and mobile device-based electronic commerce and data duplication prevention.

In addition, the embodiment of the present invention illustrates a case in which a data transmission between the mobile device and the portable integrated security storage device is performed through a communication interface of a wired scheme, but a wireless communication interface may be used therefor. Here, as an example of the wireless communication interface, near field communications or the like, such as Bluetooth, infrared communication, WiFi, or the like may be used.

Also, as described above, the present invention manages universal authentication information and a password and provides the portable integrated security storage device including the large capacity memory, and thus can integratedly support a personal computer and mobile terminal-based electronic commerce and data duplication prevention and also substitute for the existing OTP, USIM or public certificate, or the like.

While the invention has been shown and described with respect to the particular embodiments, it will be understood by those skilled in the art that various changes and modifications may be made without departing from the scope of the invention as defined in the following claims.

What is claimed is:

1. A portable integrated security storage device comprising:
a password generation module for generating a password;
a universal authentication module for storing universal authentication information;
a communication interface connected to an external system for transmitting and receiving data with the external system; and
a memory for storing the received data received through communication with the external system,
wherein the password and universal authentication information are transmitted to the external system for user authentication and device authentication, and encrypted data and a service secret key are received from the external system and stored in the memory.

2. The device of claim 1, wherein, in the device, the universal authentication information and one-time password are transmitted to the external system and the service secret key is received therefrom by using a Diffie-Hellman key exchange method.

3. The device of claim 1, wherein the password generated by the password generation module is OTP.

4. The device of claim 1, wherein the universal authentication module uses a universal subscriber identity module (USIM).

5. The device of claim 1, wherein the memory supports a universal serial bus (USB) interface or a secure digital (SD) card interface.

6. The device of claim 1, wherein the communication interface is a wired or wireless communication interface.

7. The device of claim 1, further comprising a power control module for supplying power to the device.

8. A service processing apparatus using a portable integrated security storage device comprising:
a service request unit for receiving a password and universal authentication information from the portable integrated security storage device which manages the password and the universal authentication information, and then providing the password, the universal authentication information and user encryption information for generation of a service secret key to a service providing server connected through a wired/wireless communications network to request a service;
a secret key processing unit for receiving the encryption information used for the generation of the service secret key from the service providing server, and then generating the service secret key by using the encryption information, and storing the generated service secret key in the portable integrated security storage device; and
a data processing unit for receiving encrypted data from the service providing server in response to a service request from the service request unit, decoding the encrypted data by using the service secret key stored in the portable integrated security storage device or storing the encrypted data in the portable integrated security storage device.

9. The apparatus of claim 8, wherein the apparatus is connected to the portable integrated security storage device through a wired or wireless communication interface.

10. The apparatus of claim 8, wherein the apparatus requests authentication by using the universal authentication information and password and receives the service secret key generated by the secret key processing unit through the portable integrated security storage device and a Diffie-Hellman key exchange method.

11. The apparatus of claim 8, wherein the apparatus includes a mobile device.

12. A service processing method using a portable integrated security storage device comprising:
receiving a password and universal authentication information when the portable integrated security storage device which manages the password and the universal authentication information is connected;
providing the password, the universal authentication information and user encryption information for generation of a service secret key to a service providing server connected through a wired/wireless communications network to request a service;
receiving encryption information used for the generation of the service secret key from the service providing server;
generating the service secret key by using the received encryption information, and storing the generated service secret key in the portable integrated security storage device;
receiving data encrypted by using the service secret key from the service providing server; and
decoding the encrypted data by using the service secret key stored in the portable integrated security storage device or storing the encrypted data in the portable integrated security storage device.
